(19) United States
(12) Patent Application Publication
(10) Pub. No.: US 2018/0105172 A1
(43) Pub. Date: Apr. 19, 2018

(54) ADVANCED DRIVER ASSISTANCE SYSTEM

(71) Applicant: DENSO International America, Inc., Southfield, MI (US)

(72) Inventors: Matthew GESCH, Livonia, MI (US); Jin KURUMISAWA, Novi, MI (US); Takayuki KIMURA, Kariya-city (JP)

(21) Appl. No.: 15/292,573

(22) Filed: Oct. 13, 2016

(51) Int. Cl. B60W 30/16; G08G 1/16; B60W 30/14; G01G 19/02

(52) U.S. Cl. CPC B60W 30/16; G08G 1/166; B60T 2250/02; B60W 30/143; G01G 19/02; B60W 30/14

(57) ABSTRACT

The present disclosure provides an advanced driver assistance system that includes a trailer detecting unit detecting whether a trailer is connected with a vehicle, and a trailer mass estimation unit estimating a mass of the trailer when the trailer detecting unit detects that the trailer is connected with the vehicle. The trailer mass estimation unit outputs a trailer mass signal. The advanced driver assistance system further includes a following distance determination unit determining a parameter of a following distance from another vehicle driving ahead of the vehicle to have the vehicle automated to follow the other vehicle at the following distance based on the parameter of the following distance. Moreover, the advanced driver assistance system includes a following distance adjustment unit adjusting the parameter of the following distance, which is determined by the following distance determination unit, based on the trailer mass signal.

### FIELD

The present disclosure relates to an advanced driver assistance system for a vehicle.

### BACKGROUND

This section provides background information related to the present disclosure which is not necessarily prior art.

An advanced driver assistance system has been used in a vehicle to help a driver in driving process. Generally, a conventional advanced driver assistance system may provide adaptive cruise control, automate braking, and so forth.

One of the conventional advanced driver assistance systems may be used in a vehicle which is connected with a trailer. When the vehicle tows a heavy trailer, it may be hard for the conventional advanced driver assistance system to provide stable control for the vehicle.

### SUMMARY

This section provides a general summary of the disclosure, and is not a comprehensive disclosure of its full scope or all of its features.

An aspect of the present disclosure provides an advanced driver assistance system that includes a trailer detecting unit detecting whether a trailer is connected with a vehicle, and a trailer mass estimation unit estimating a mass of the trailer when the trailer detecting unit detects that the trailer is connected with the vehicle. The trailer mass estimation unit outputs a trailer mass signal. The advanced driver assistance system further includes a following distance determination unit determining a parameter of a following distance from another vehicle driving ahead of the vehicle to have the vehicle automated to follow the other vehicle at the following distance based on the parameter of the following distance. Moreover, the advanced driver assistance system includes a following distance adjustment unit adjusting the parameter of the following distance, which is determined by the following distance determination unit, based on the trailer mass signal.

Another aspect of the present disclosure provides an advanced driver assistance system that includes a trailer detecting unit detecting whether a trailer is connected with a vehicle, and a trailer mass estimation unit estimating a mass of the trailer when the trailer detecting unit detects that the trailer is connected with the vehicle. The trailer mass estimation unit outputs a trailer mass signal. The advanced driver assistance system further includes a brake timing determination unit determining a parameter of brake timing to have the vehicle automated to start braking based on the parameter of the brake timing. Moreover, the advanced driver assistance system includes a brake timing adjustment unit adjusting the parameter of the brake timing, which is determined by the brake timing determination unit, based on the trailer mass signal.

Furthermore, another aspect of the present disclosure provides an advanced driver assistance system that includes a trailer detecting unit detecting whether a trailer is connected with a vehicle, and a trailer mass estimation unit estimating a mass of the trailer when the trailer detecting unit detects that the trailer is connected with the vehicle. The trailer mass estimation unit outputs a trailer mass signal. The advanced driver assistance system further includes a deceleration determination unit determining a parameter of deceleration to have the vehicle automated to decelerate based on the parameter of the deceleration. Moreover, the advanced driver assistance system includes a deceleration adjustment unit adjusting the parameter of the deceleration, which is determined by the deceleration determination unit, based on the trailer mass signal.

Further areas of applicability will become apparent from the description provided herein. The description and specific examples in this summary are intended for purposes of illustration only and are not intended to limit the scope of the present disclosure.

### DRAWINGS

The above and other objects, features and advantages of the present invention will become more apparent from the following detailed description made with reference to the accompanying drawings. The drawings described herein are for illustrative purposes only of selected embodiments and not all possible implementations, and are not intended to limit the scope of the present disclosure.

FIG. 1 is a plane view schematically illustrating a vehicle towing a light trailer according to the first embodiment;

FIG. 2 is a plane view schematically illustrating the vehicle towing a heavy trailer according to the first embodiment;

FIG. 3 is a block diagram illustrating an advanced driver assistance system according to the first embodiment;

FIG. 4 is a flowchart executed by the advanced driver assistance system according to the first embodiment;

FIG. 5 is a graph showing a following distance relative to a velocity according to the first embodiment; and

FIG. 6 is a graph showing deceleration relative to time according to the first embodiment.

### DETAILED DESCRIPTION

A plurality of embodiments of the present disclosure will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts may be combined. The embodiments may be partially combined even if it is not explicitly described that the embodiments may be combined, provided there is no harm in the combination.

### First Embodiment

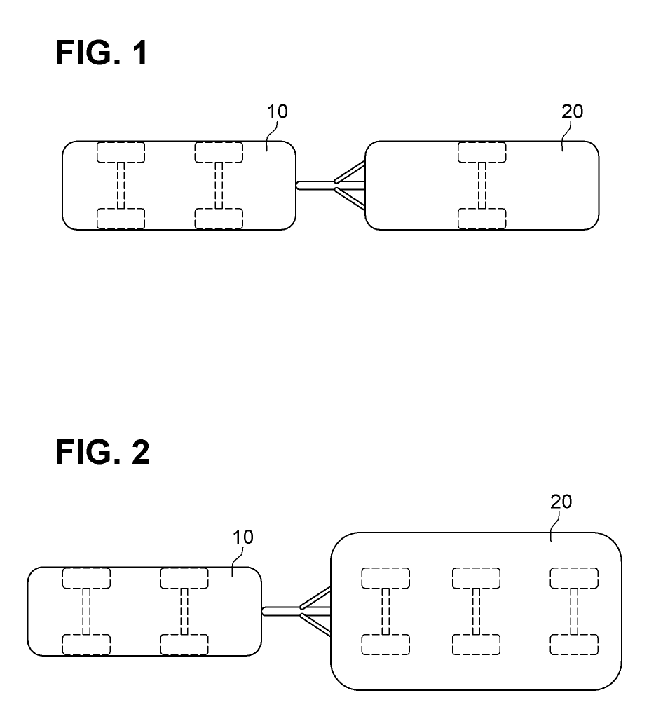

Configuration of an advanced driver assistance system 100 according to the first embodiment will be described. FIG. 1 depicts a plane view schematically illustrating a vehicle 10 towing a trailer 20 according to the present embodiment. FIG. 1 shows the vehicle 10 that tows the trailer 20, which has small size and one pair of wheels, on a rear side of the vehicle 10. On the other hand, FIG. 2 depicts a plane view schematically illustrating the vehicle 10 towing the trailer 20 according to the present embodiment. FIG. 2 shows the vehicle 10 that tows the trailer 20, which has large size and three pairs of wheels.

The advanced driver assistance system 100 is equipped in the vehicle 10. The vehicle 10 is connected with the trailer 20. In other words, the advanced driver assistance system 100 is installed in the vehicle 10, which tows a trailer 20.

In this example, the vehicle 10 is a passenger vehicle. The vehicle 10 has an attachment, which is not described in FIG. 1, for connection with the trailer 20. In general, the attachment is disposed at a rear end of the vehicle 10.

The trailer 20 is connected to the vehicle 10 such that the trailer 20 is capable to pivot on the attachment of the vehicle 10. Thereby, the vehicle 10 may drive smoothly even if the vehicle 10 is connected with the trailer 20. Weight of the trailer 20 depends on a trailer size, a trailer type, and so forth. In general, a house-type trailer is usually heavier than a boat-type trailer.

In this example, the trailer 20 has a trailer brake system, which is connected with a brake control system of the vehicle 10 electrically or pneumatically so that a certain voltage or pressure is applied to the trailer brake system to brake the trailer 20. Furthermore, the vehicle or trailer brake system can include, but is not limited to a brake pressure sensor, which detects brake pressure, and a brake temperature sensor, which detects brake temperature.

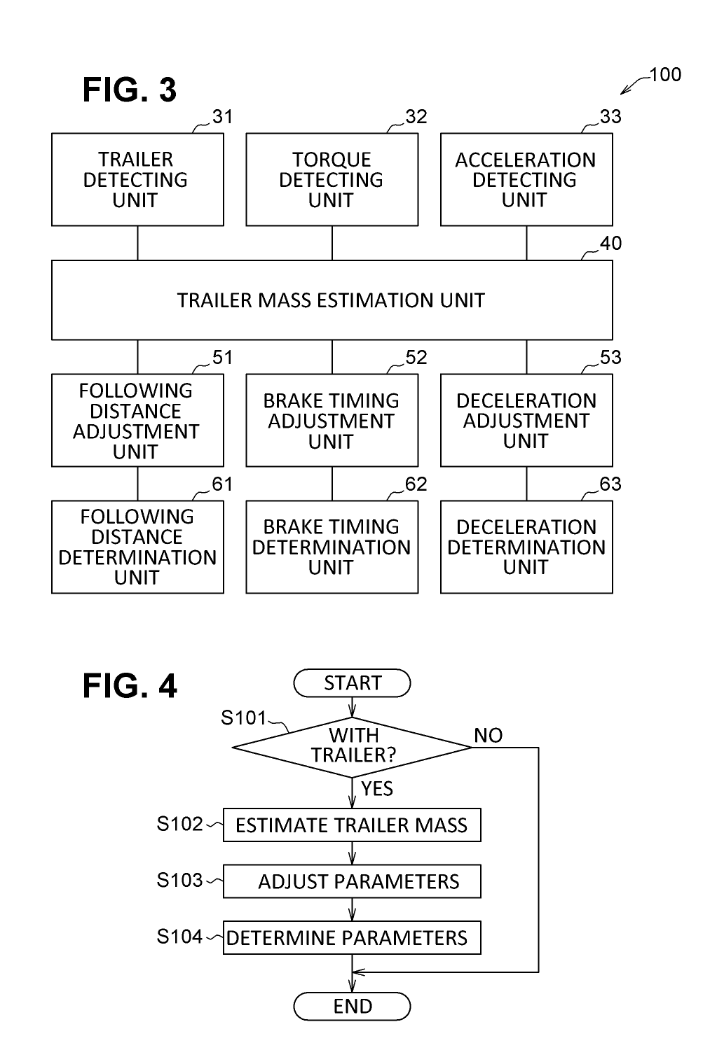

FIG. 3 depicts a block diagram illustrating an advanced driver assistance system 100 according to the present embodiment. FIG. 3 shows the advanced driver assistance system 100 that includes a trailer detecting unit 31, a torque detecting unit 32, an acceleration detecting unit 33, a trailer mass estimation unit 40, a following distance adjustment unit 51, a brake timing adjustment unit 52, a deceleration adjustment unit 53, a following distance determination unit 61, a brake timing determination unit 62, and a deceleration determination unit 62. The advanced driver assistance system 100 provides a driver with help in driving process.

The trailer detecting unit 31 is configured to detect whether the vehicle 10 is connected with the trailer 20. In this example, the trailer detecting unit 31 detects that by trailer brake information from the trailer brake system, such as the applied voltage, the brake pressure, the brake temperature, and so forth. When the trailer detecting unit 31 detects that the vehicle 10 is connected with the trailer 20 based on the trailer brake information, the trailer detecting unit 31 outputs a trailer signal to the torque detecting unit 32 and the acceleration detecting unit 33.

The torque detecting unit 32 is configured to detect a torque on an engine of the vehicle 10. In this example, the torque detecting unit 32 detects the torque using a torque sensor, which is included in an engine control system. The torque detecting unit 32 outputs a torque signal based on the detected torque to the trailer mass estimation unit 40.

The acceleration detecting unit 33 is configured to detect acceleration of the vehicle 10. In this example, the acceleration detecting unit 33 detects the acceleration using an acceleration sensor, which is included in an airbag control system. The acceleration detecting unit 33 outputs an acceleration signal based on the detected acceleration to the trailer mass estimation unit 40.

The trailer mass estimation unit 40 is configured to estimate a mass of the trailer 20 when the trailer detecting unit 31 detects that the trailer 20 is connected with the vehicle 10. In this example, the trailer mass estimation unit 40 estimates the mass of the trailer 20 based on the torque signal, the acceleration signal, and the trailer brake information. The trailer mass estimation unit 40 outputs a trailer mass signal based on the estimated mass of the trailer 20 to the following distance adjustment unit 51, the brake timing adjustment unit 52, and the deceleration adjustment unit 53.

In this example, to provide stable control for the vehicle 10 towing the trailer 20, the advanced driver assistance system 100 has the three adjustment units 51, 52, 53 that adjust parameters for the stable control. In other words, a parameter of the following distance, a parameter of the brake timing, and a parameter of the deceleration are adjusted according to the mass of the trailer 20, and thereby, the advanced driver assistance system 100 may provide the stable control even though the vehicle 10 tows the trailer 20.

First, the parameter of the following distance is determined by the following distance determination unit 61. The following distance determination unit 61 is configured to determine the parameter of the following distance from another vehicle driving ahead of the vehicle 10. The vehicle 10 is automated to follow the other vehicle at the following distance based on the parameter of the following distance. In this example, the following distance determination unit 61 is used for adaptive cruise control.

Before such a determination, the parameter of the following distance is adjusted by the following distance adjustment unit 51. The following distance adjustment unit 51 is configured to adjust the parameter of the following distance based on the trailer mass signal. More specifically, in this example, the following distance adjustment unit 51 adjusts the parameter of the following distance based on the information from the trailer brake system in addition to the trailer mass signal. The following distance adjustment unit 51 adjusts the parameter of the following distance so that the following distance is longer as the mass of the trailer 20 is heavier. When the trailer 20 has the trailer brake system, the parameter of the following distance is adjusted so that the parameter of the following distance is closer to that when the vehicle 10 tows no trailer, than that when the trailer 20 has no trailer brake system. The following distance adjustment unit 51 outputs a following distance adjustment signal to the following distance determination unit 61. Eventually, the following distance determination unit 61 determines the parameter of the following distance based on the following distance adjustment signal.

Second, the parameter of the brake timing is determined by the brake timing determination unit 62. The brake timing determination unit 62 is configured to determine the parameter of the brake timing of the vehicle 10. The vehicle 10 is automated to start braking at the brake timing based on the parameter of the brake timing. In this example, the brake timing determination unit 62 is used for the adaptive cruise control.

Before such a determination, the parameter of the brake timing is adjusted by the brake timing adjustment unit 52. The brake timing adjustment unit 52 is configured to adjust the parameter of the brake timing based on the trailer mass signal. More specifically, in this example, the brake timing adjustment unit 52 adjusts the parameter of the brake timing based on the information from the trailer brake system in addition to the trailer mass signal. The brake timing adjustment unit 52 adjusts the parameter of the brake timing so that the brake timing is earlier as the mass of the trailer 20 is heavier. When the trailer 20 has the trailer brake system, the parameter of the brake timing is adjusted so that the parameter of the brake timing is closer to that when the vehicle 10 tows no trailer, than that when the trailer 20 has no trailer brake system. The brake timing adjustment unit 52 outputs a brake timing adjustment signal to the brake timing determination unit 62. Eventually, the brake timing determination unit 62 determines the parameter of the brake timing based on the brake timing adjustment signal.

Finally, the parameter of the deceleration is determined by the deceleration determination unit 63. The deceleration determination unit 63 is configured to determine the parameter of the deceleration of the vehicle 10. The vehicle 10 is automated to decelerate based on the parameter of the deceleration. In this example, the deceleration determination unit 63 is used for the adaptive cruise control.

Before such a determination, the parameter of the deceleration is adjusted by the deceleration adjustment unit 53. The deceleration adjustment unit 53 is configured to adjust the parameter of the deceleration based on the trailer mass signal. More specifically, in this example, the deceleration adjustment unit 53 adjusts the parameter of the deceleration based on the information from the trailer brake system in addition to the trailer mass signal. The deceleration adjustment unit 53 adjusts the parameter of the deceleration so that the deceleration is weaker as the mass of the trailer 30 is heavier. In other words, the deceleration adjustment unit 53 adjusts the parameter of the deceleration so that the deceleration rate reduces as the mass of the trailer 30 is heavier. When the trailer 20 has the trailer brake system, the parameter of the deceleration is adjusted so that the parameter of the deceleration is closer to that when the vehicle 10 tows no trailer, than that when the trailer 20 has no trailer brake system. The deceleration adjustment unit 53 outputs a deceleration adjustment signal to the deceleration determination unit 63. Eventually, the deceleration determination unit 63 determines the parameter of the deceleration based on the deceleration adjustment signal.

FIG. 4 depicts a flowchart executed by the advanced driver assistance system 100 according to the present embodiment. FIG. 4 shows process of the advanced driver assistance system 100 that has Steps 101-104 between Start and End. The process starts proceeding accordingly, for example, when the vehicle starts to drive, when the adaptive cruise control turns on, and so forth.

At first, the process proceeds from Start to Step 101 at which the trailer detecting unit 31 detects whether the vehicle 10 is connected with the trailer 20. When the trailer detecting unit 31 detects that the vehicle 10 is connected with no trailer, the process proceeds to End. On the other hands, when the trailer detecting unit 31 detects that the vehicle 10 is connected with the trailer 20, the process proceeds to Step 102.

At Step 102, the trailer mass estimation unit 40 estimates the mass of the trailer 20, which is connected to the vehicle 10. In this example, the torque, the acceleration, and the trailer brake information are already detected by the other systems, and thereby the trailer mass estimation unit 32 estimates the mass of the trailer 20 based on the detected torque, the detected acceleration, and the trailer brake information.

After Step 102, the process proceeds to Step 103. At Step 103, each of the adjustment units 51, 52, 53 adjusts the parameters respectively based on the estimated mass of the trailer 20, which are obtained at Steps 102, and the trailer brake information. Specifically, the following distance adjustment unit 51 adjusts the parameter of the following distance. The brake timing distance adjustment unit 52 adjusts the parameter of the brake timing. The deceleration adjustment unit 53 adjusts the parameter of the deceleration.

After Step 103, the advanced driver assistance system 100 executes Step 104 at which each of the determination units 61, 62, 63 determines the parameters respectively based on the adjustment signal. Specifically, the following distance determination unit 61 determines the parameter of the following distance. The brake timing determination unit 62 determines the parameter of the brake timing. The deceleration determination unit 63 determines the parameter of the deceleration. After such determinations, the process is ended.

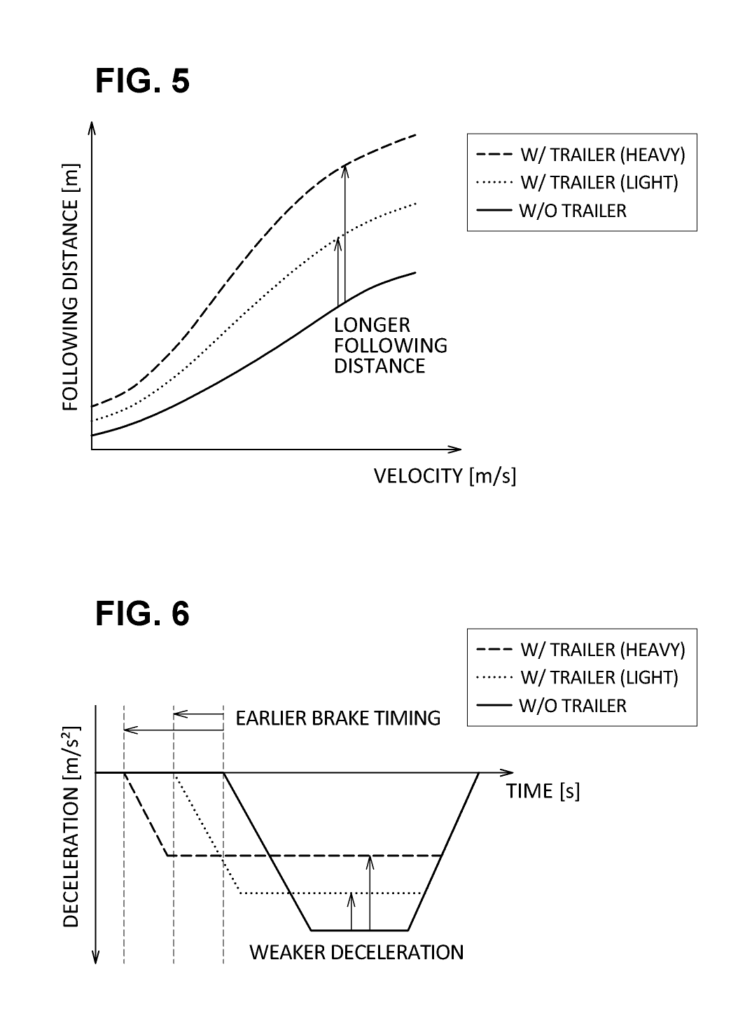

FIG. 5 depicts a graph showing the following distance relative to a velocity according to the present embodiment. FIG. 5 shows the three cases of the vehicle 10. The solid line, which is described in FIG. 5, is the first case of the vehicle 10 towing no trailer. The dotted line, which is described in FIG. 5, is the second case of the vehicle 10 towing the trailer 20, the mass of which is lighter than that of the third case. The dashed line, which is described in FIG. 5, is the third case of the vehicle 10 towing the trailer 20, the mass of which is heavier than that of the second case.

In all of the cases, the vehicle 10 is automated to drive so that the velocity of the vehicle 10 is faster as the following distance is longer. Thereby, the vehicle 10 may follow the other vehicle driving ahead of the vehicle 10 at the following distance enough to stop safely. To stop the vehicle 10 safely, the following distance determination unit 61 determines the parameter of the following distance.

However, to stop the vehicle 10 towing the trailer 20 under the stable control, the vehicle 10 towing the trailer 20 needs the longer following distance than the vehicle 10 towing no trailer. More specifically, the vehicle 10 towing the heavy trailer 20, such as the house-type trailer, needs the longer following distance than the vehicle towing the light trailer 20, such as the boat-type trailer, and a small utility-type trailer. Therefore, the following distance adjustment unit 51 adjusts the parameter of the following distance so that the following distance is longer as the mass of the trailer 20 is heavier. Thereby, even though the vehicle 10 tows the heavy trailer 20, the advanced driver assistance system 100 may provide the stable control for the vehicle 10.

FIG. 6 depicts a graph showing the deceleration relative to time according to the present embodiment. Similarly, FIG. 6 shows the three cases of the vehicle 10 as well as FIG. 5. The solid line, which is described in FIG. 6, is the first case of the vehicle 10 towing no trailer. The dotted line, which is described in FIG. 6, is the second case of the vehicle 10 towing the light trailer 20. The dashed line, which is described in FIG. 6, is the third case of the vehicle 10 towing the heavy trailer 20.

In all of the cases, the vehicle 10 is automated to start braking so that the vehicle 10 stops completely at a certain timing. To stop the vehicle 10 safely, the brake timing determination unit 62 determines the parameter of the brake timing.

However, to stop the vehicle 10 towing the trailer 20 under the stable control, the vehicle 10 towing the trailer 20 needs longer time from the brake timing to the certain timing than the vehicle 10 towing no trailer. More specifically, the vehicle 10 towing the heavy trailer 20 needs longer time than the vehicle 10 towing the light trailer 20. Therefore, the brake timing adjustment unit 52 adjusts the parameter of the brake timing so that the brake timing is earlier as the mass of the trailer 20 is heavier. Thereby, even though the vehicle 10 tows the heavy trailer 20, the advanced driver assistance system 100 may provide the stable control for the vehicle 10.

Additionally, in all of the cases, the vehicle 10 is automated to decelerate during braking so that the vehicle 10 stops at the certain timing. To stop the vehicle 10 safely, the deceleration determination unit 63 determines the parameter of the deceleration.

However, to stop the vehicle 10 towing the trailer 20 under the stable control, the vehicle 10 towing the trailer 20 needs weaker deceleration than the vehicle 10 towing no trailer. More specifically, the vehicle 10 towing the heavy trailer 20 needs weaker deceleration than the vehicle 10 towing the light trailer 20. Therefore, the deceleration adjustment unit 53 adjusts the parameter of the deceleration so that the deceleration is weaker as the mass of the trailer 20 is heavier. Thereby, even though the vehicle 10 tows the heavy trailer 20, the advanced driver assistance system 100 may provide the stable control for the vehicle 10.

Thus, as shown in FIG. 5 and FIG. 6, the advanced driver assistance system 100 may provide the vehicle 10 towing the heavy trailer 20 with the stable control due to the parameter adjustments for the braking timing, the deceleration, and the following distance.

### Other Embodiments

In the first embodiment, the advanced driver assistance system 100 includes the trailer detecting unit 31. However, the advanced driver assistance system is not limited to own the trailer detecting unit, and may use a common unit to detect whether a vehicle is connected with a trailer. In that case, such a common unit is included in another system, for example, a trailer control system, and so forth.

In the first embodiment, the vehicle 10 is a passenger vehicle. However, the vehicle towing the trailer is not limited to a passenger vehicle, and may be another vehicle, such as a tractor trailer, and so forth.

In the first embodiment, the trailer 20 has the trailer brake system. However, the trailer brake system is not limited to be necessary for the advanced driver assistance system. The advanced driver assistance system may provide the stable control for the vehicle towing the trailer having no brake system. Moreover, the brake pressure sensor and the brake temperature sensor are not limited to be necessary for the advanced driver assistance system as well.

In the first embodiment, the trailer detecting unit 31 detects whether the vehicle 10 is connected with the trailer 20 by the trailer brake information. However, the trailer detecting unit is not limited to be such a detecting structure, and may have a detecting device, for example, an ultrasonic sensor, a radar sensor, a LIDAR sensor, a laser sensor, a rear view camera, a touch sensor, and so forth.

In the first embodiment, the trailer mass estimation unit 40 estimates the mass of the trailer 20 based on the torque signal, the acceleration signal, and the trailer brake information. However, the trailer brake information is not required to estimate the mass of the trailer. When the trailer has no trailer brake system, the trailer mass estimation unit may estimate the mass of the trailer based on the torque signal and the acceleration signal without the trailer brake information.

In the first embodiment, the adjustment units 51, 52, 53 adjust the parameters based on the trailer mass signal and the trailer brake information. However, the trailer brake information is not required to adjust the parameters. The adjustment units may adjust the parameters respectively based on the mass of the trailer without the trailer brake information.

In the first embodiment, the torque detecting unit 32 detects the torque using a torque sensor, which is included in an engine control system. However, the torque sensor is not limited to be included in the engine control system, and may be owned by the trailer detecting unit separately from other systems.

In the first embodiment, the acceleration detecting unit 33 detects the acceleration using an acceleration sensor, which is included in an airbag control system. However, the acceleration sensor is not limited to be included in the airbag control system, and may be owned by the acceleration detecting unit separately from other systems.

In the first embodiment, the determination units 61, 62, 63 are used for the adaptive cruise control. However, the control speed determination unit is not limited to be used for the adaptive cruise control, and may be used for autonomous driving.

In the first embodiment, the advanced driver assistance system 100 includes the following distance adjustment unit 51, the brake timing adjustment unit 52, the deceleration adjustment unit 53, the following distance determination unit 61, the brake timing determination unit 62, and the deceleration determination unit 62. However, the advanced driver assistance system is not limited to include all of the units, and may include the units just relative to the following distance, the brake timing, or the deceleration. Moreover, the advanced driver assistance system may include the units just relative to the following distance and the brake timing, the following distance and the deceleration, or the brake timing and the deceleration.

In the first embodiment, the trailer mass estimation unit 40 estimates the mass of the trailer 20 based on the torque signal and the acceleration signal. However, the trailer mass estimation unit is not limited to estimate the mass of the trailer based on the two signals, and may estimate the mass of the trailer based on other signals or information.

In the first embodiment, at Step 103, each of the adjustment units 51, 52, 53 adjusts the parameters respectively. However, the adjustment units are not limited to go on simultaneously, and may go in series. Similarly, each of the determination units 61, 62, 63 determinates the parameters respectively. However, the determination units are not limited to go on simultaneously, and may go in series as well.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

What is claimed is:

1. An advanced driver assistance system for a vehicle comprising:
a trailer detecting unit detecting whether a trailer is connected with a vehicle;
a trailer mass estimation unit estimating a mass of the trailer when the trailer detecting unit detects that the trailer is connected with the vehicle, the trailer mass estimation unit outputting a trailer mass signal;
a following distance determination unit determining a parameter of a following distance from another vehicle driving ahead of the vehicle to have the vehicle automated to follow the other vehicle at the following distance based on the parameter of the following distance; and
a following distance adjustment unit adjusting the parameter of the following distance, which is determined by the following distance determination unit, based on the trailer mass signal.

2. The advanced driver assistance system according to claim 1, wherein
the following distance adjustment unit adjusts the parameter of the following distance so that the following distance is longer as the mass of the trailer is heavier.

3. The advanced driver assistance system according to claim 1, further comprising:
a brake timing determination unit determining a parameter of brake timing to have the vehicle automated to start braking based on the parameter of the brake timing; and
a brake timing adjustment unit adjusting the parameter of the brake timing, which is determined by the brake timing determination unit, based on the trailer mass signal.

4. The advanced driver assistance system according to claim 3, wherein
the brake timing adjustment unit adjusts the parameter of the brake timing so that the brake timing is earlier as the mass of the trailer is heavier.

5. The advanced driver assistance system according to claim 1, further comprising:
a deceleration determination unit determining a parameter of deceleration to have the vehicle automated to decelerate based on the parameter of the deceleration; and
a deceleration adjustment unit adjusting the parameter of the deceleration, which is determined by the deceleration determination unit, based on the trailer mass signal.

6. The advanced driver assistance system according to claim 5, wherein
the deceleration adjustment unit adjusts the parameter of the deceleration so that the deceleration is weaker as the mass of the trailer is heavier.

7. The advanced driver assistance system according to claim 1, further comprising:
a torque detecting unit detecting a torque on an engine of the vehicle, the torque detecting unit outputting a torque signal; and
an acceleration detecting unit detecting acceleration of the vehicle, the acceleration detecting unit outputting an acceleration signal; wherein
the trailer mass estimation unit estimates the mass of the trailer based on the torque signal and the acceleration signal.

8. An advanced driver assistance system for a vehicle comprising:
a trailer detecting unit detecting whether a trailer is connected with a vehicle;
a trailer mass estimation unit estimating a mass of the trailer when the trailer detecting unit detects that the trailer is connected with the vehicle, the trailer mass estimation unit outputting a trailer mass signal;
a brake timing determination unit determining a parameter of brake timing to have the vehicle automated to start braking based on the parameter of the brake timing; and
a brake timing adjustment unit adjusting the parameter of the brake timing, which is determined by the brake timing determination unit, based on the trailer mass signal.

9. The advanced driver assistance system according to claim 8, wherein
the brake timing adjustment unit adjusts the parameter of the brake timing so that the brake timing is earlier as the mass of the trailer is heavier.

10. The advanced driver assistance system according to claim 8, further comprising:
a deceleration determination unit determining a parameter of deceleration to have the vehicle automated to decelerate based on the parameter of the deceleration; and
a deceleration adjustment unit adjusting the parameter of the deceleration, which is determined by the deceleration determination unit, based on the trailer mass signal.

11. The advanced driver assistance system according to claim 10, wherein
the deceleration adjustment unit adjusts the parameter of the deceleration so that the deceleration is weaker as the mass of the trailer is heavier.

12. The advanced driver assistance system according to claim 8, further comprising:
a torque detecting unit detecting a torque applied to the vehicle from the trailer, the torque detecting unit outputting a torque signal; and
an acceleration detecting unit detecting acceleration of the vehicle, the acceleration detecting unit outputting an acceleration signal; wherein
the trailer mass estimation unit estimates the mass of the trailer based on the torque signal and the acceleration signal.

13. An advanced driver assistance system for a vehicle comprising:
a trailer detecting unit detecting whether a trailer is connected with a vehicle;
a trailer mass estimation unit estimating a mass of the trailer when the trailer detecting unit detects that the trailer is connected with the vehicle, the trailer mass estimation unit outputting a trailer mass signal;
a deceleration determination unit determining a parameter of deceleration to have the vehicle automated to decelerate based on the parameter of the deceleration; and
a deceleration adjustment unit adjusting the parameter of the deceleration, which is determined by the deceleration determination unit, based on the trailer mass signal.

14. The advanced driver assistance system according to claim 13, wherein
the deceleration adjustment unit adjusts the parameter of the deceleration so that the deceleration is weaker as the mass of the trailer is heavier.

15. The advanced driver assistance system according to claim 14, further comprising:
a torque detecting unit detecting a torque applied to the vehicle from the trailer, the torque detecting unit outputting a torque signal; and
an acceleration detecting unit detecting acceleration of the vehicle, the acceleration detecting unit outputting an acceleration signal; wherein
the trailer mass estimation unit estimates the mass of the trailer based on the torque signal and the acceleration signal.
